(19) United States
(12) Patent Application Publication
(10) Pub. No.: US 2007/0288714 A1
(43) Pub. Date: Dec. 13, 2007

(54) Access control apparatus

(75) Inventor: Takahiro Nakamura, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/634,100

(22) Filed: Dec. 6, 2006

(30) Foreign Application Priority Data
Jun. 8, 2006 (JP) 2006-160097

(51) Int. Cl. G06F 12/14

(52) U.S. Cl. 711/163

(57) ABSTRACT

An access management apparatus manages access to stored files from information processing apparatuses. The access management apparatus includes a network communication section, an access privilege policy setting section and an access control section. The network communication section has a plurality of protocols for accepting access to the files from the information processing apparatuses. The access privilege policy setting section enables one of the protocols when limitation of access to the files is started. The access control section limits access to be accepted when the one of the protocols is enabled, in accordance with settings stored in the access control section.

### BACKGROUND

1. Technical Field

The invention relates to an access management apparatus for managing access to stored/held files from information processing apparatuses and particularly relates to an access management apparatus in which a free access environment and a limited access environment can be provided when the access management apparatus is provided with plural protocols for accepting access from information processing apparatuses.

2. Related Art

Images of paper documents read by a scanner function, FAX images received by a FAX function, etc. are stored as electronic documents in a folder on an external controller (file server) connected to a multifunctional machine (MFP) compositely provided with a copying function, the scanner function and the FAX function, and access to the stored electronic documents from other information processing apparatuses is accepted by the file server so that document sharing can be achieved.

When various kinds of information processing apparatuses such as a PC (personal computer), a PDA (personal digital assistant), a mobile phone, etc. can gain access to the documents in such a file server, convenience is improved. Therefore, configuration may be made in such a manner that a plurality of network protocols (such as HTTP, FTP, SMB, etc.) in accordance with various kinds of information processing apparatuses and communication environments are provided in the file server so that the file server can accept access from the various kinds of information processing apparatuses.

### SUMMARY

According to an aspect of the invention, an access management apparatus manages access to stored files from information processing apparatuses. The access management apparatus includes a network communication section, an access privilege policy setting section and an access control section. The network communication section has a plurality of protocols for accepting access to the files from the information processing apparatuses. The access privilege policy setting section enables one of the protocols when limitation of access to the files is started. The access control section limits access to be accepted when the one of the protocols is enabled, in accordance with settings stored in the access control section.

### BRIEF DESCRIPTION OF THE DRAWINGS

Exemplary embodiments of the invention will be described in detailed below with reference to the accompanying drawings wherein:

FIG. 1 is a block diagram for explaining the configuration of a file sharing system according to an exemplary embodiment of the invention;

FIG. 2 is a view for explaining an access privilege management table according to the exemplary embodiment of the invention; and

FIG. 3 is a flow chart for explaining a control procedure of access control according to the exemplary embodiment of the invention.

### DETAILED DESCRIPTION

The exemplary embodiments of the invention will be described.

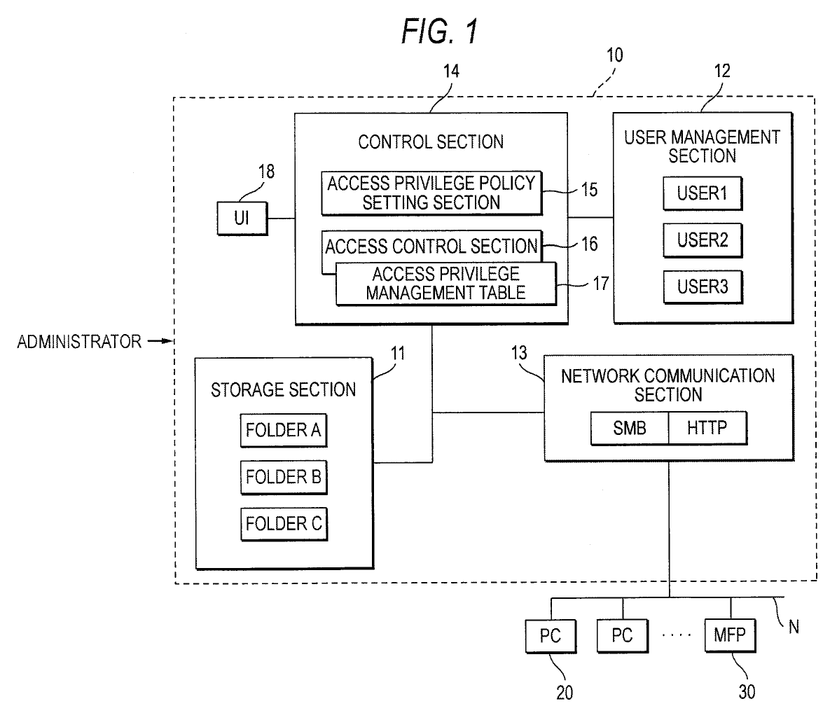

As the configuration of a system according to this exemplary embodiment is shown in FIG. 1, the system is formed as a file sharing system in which an access management apparatus 10 for storing/holding files such as folders and documents is connected to plural information processing apparatuses such as PCs 20 and an MFP 30 through a network N, so that each information processing apparatus is allowed to gain access to the files held in the access management apparatus 10.

The access management apparatus 10 includes a storage section 11 for storing/holding files (such as folders and documents), a user management section 12 for managing users who use the system, a network communication section 13 for accepting access from information processing apparatuses such as PCs 20 and an MFP 30, a control section 14 for limiting access to the files, and a user interface (UI) 18 for accepting various information inputs from an administrator.

The storage section 11 stores/holds documents in accordance with each folder. As shown in FIG. 1, the storage section 11 has folders “Folder A”, “Folder B” and “Folder C” in which various documents are stored.

The user management section 12 holds identification information of the users using the system. As shown in FIG. 1, pieces of user identification information “User1”, “User2” and “User3” are registered in the user management section 12.

The network communication section 13 has plural protocols for accepting access from the respective information processing apparatuses. As shown in FIG. 1, the network communication section 13 has two protocols SMB and HTTP.

The control section 14 has an access privilege policy setting section 15 for controlling processing concerned with access limitation, an access control section 16 for performing access control, and an access privilege management table 17 for holding access privileges each of which defines an access limitation range.

In this exemplary embodiment, a program is executed by a computer of the access management apparatus 10 to thereby implement the access privilege policy setting section 15, the access control section 16 and the access privilege management table 17.

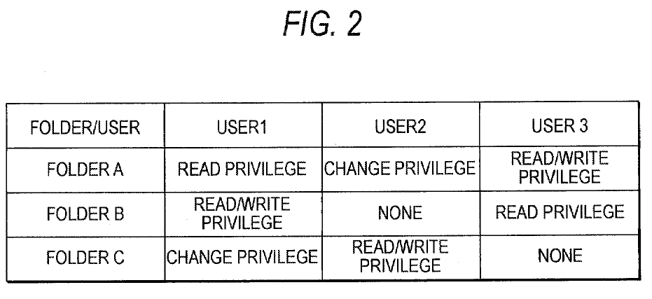

Although the access privilege management table 17 of this exemplary embodiment holds the access privileges of the respective users in accordance with each folder as shown in FIG. 2, such access privileges may be held in accordance with each document. In addition, the access privileges given to the respective users may be replaced by access privileges given to respective user groups each of which includes plural users or by access privileges given to respective information apparatuses.

The access privileges allowed to be set in the access privilege management table 17 of this exemplary embodiment include “none”, “read privilege”, “read/write privilege” and “change privilege”. The “none” expresses forbiddance of any access to a folder. The “read privilege” expresses permission to read documents stored in a folder. The “read/write privilege” expresses permission to edit and store documents read from a folder and add a new document into the folder in addition to the read privilege. The “change privilege” expresses permission to change access privileges given to documents and sub-folders under a folder in addition to the read/write privilege. (That is, a user having the change privilege set on a folder is privileged in the same level as the administrator's level with respect to the folder.)

The access privilege management table 17 is set by the access control section 16 in accordance with access privilege inputs accepted from the administrator by the UI 18. According to the example shown in FIG. 2, Folder A is configured so that “read privilege” is set for User1, “change privilege” is set for User2, and “read/write privilege” is set for User3. Folder B is configured so that “read/write privilege” is set for User1, “none” is set for User2, and “read privilege” is set for User3. Folder C is configured so that “change privilege” is set for User1, “read/write privilege” is set for User2, and “none” is set for User3.

The access control section 16 has an access control function by which access from each user through one of the information processing apparatuses such as PCs 20 or an MFP 30 is limited in accordance with a corresponding access privilege in the access privilege management table 17, as well as the access privilege setting function by which access privileges are set in the access privilege management table 17 in accordance with the administrator's inputs as described above.

The access privilege policy setting section 15 controls processing concerned with access limitation, in accordance with request inputs accepted from the administrator by the UI 18.

When there is a request to start setting an access privilege, the access privilege policy setting section 15 enables the access privilege setting function of the access control section 16 to set the access privilege in the access privilege management table 17. Incidentally, the access privilege policy setting section 15 disables all protocols included in the network communication section 13 in order to cut off access from the other users during the administrator's setting of the access privilege, so that the administrator can set the access privilege without awareness of the other users.

When there is a request to start access limitation, the access privilege policy setting section 15 enables the access control function of the access control section 16 to start access limitation in accordance with access privileges set in the access privilege management table 17 and enables only one of protocols included in the network communication mans 13 while disabling the other protocols. That is, only access based on the enabled protocol is accepted while access based on the disabled protocols is cut off, so that the access based on the enabled protocol is limited in accordance with the contents set in the access privilege management table 17.

When there is a request to cancel the access limitation, the access privilege policy setting section 15 disables the access privilege setting function and the access control function of the access control section 16 in order to terminate the access limitation. At the same time, the access privilege policy setting section 15 enables all the protocols included in the network communication section 13. That is, all the users can freely gain access based on all the protocols.

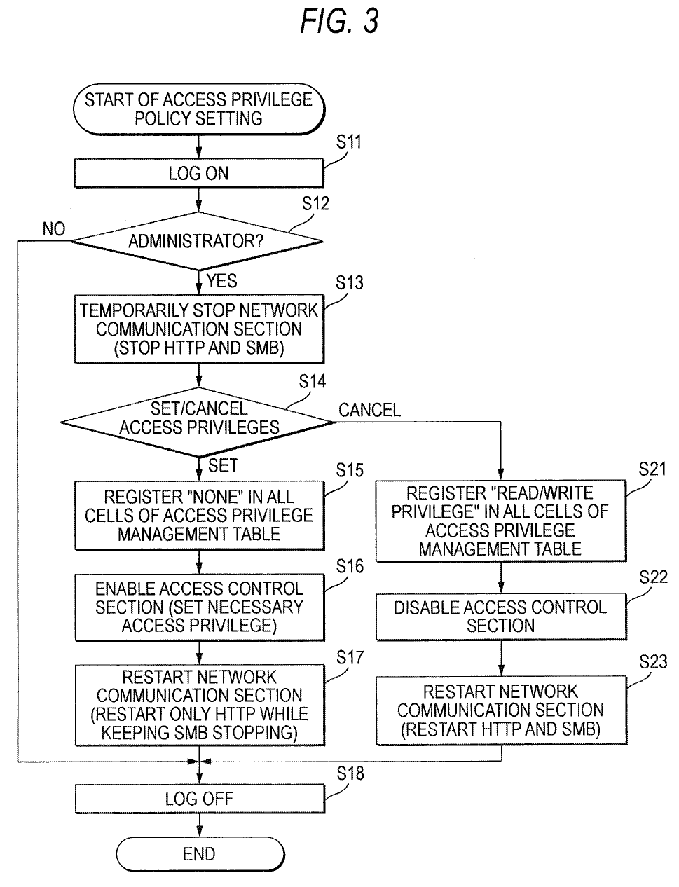

FIG. 3 shows a flow chart of processing for controlling starting or canceling of access limitation. Control of the access limitation will be described specifically with reference to FIG. 3. Before control, access limitation has not been made yet, so that all the users can freely gain access based on all the protocols included in the network communication section 13.

When a logon screen for prompting the administrator to input the administrator's ID and password is displayed on the UI 18 and the administrator inputs the administrator's ID and password to ask for logon (step S11), the access privilege policy setting section 15 compares the inputted administrator's ID and password with predetermined administrator's ID and password to determine whether the logon procedure is executed by the administrator or not (step S12).

When the administrator's ID or password is not coincident (NO), the processing is terminated without execution (step S18) because the logon procedure has been not executed by the administrator. When the administrator's ID and password are coincident (YES), the following processing is executed because the logon procedure has been executed by the administrator.

First, the access privilege policy setting section 15 stops and disables all the protocols (such as HTTP and SMB) included in the network communication section 13 so that any access from the other users cannot be accepted while the administrator is working (step S13).

In the condition that a menu screen for accepting an instruction to start access privilege setting or an instruction to cancel access limitation is displayed on the UI 18, the access management apparatus waits for an instruction from the administrator (step S14). In this exemplary embodiment, the administrator is requested to select one of the protocols when the administrator issues an instruction to start access privilege setting, so that the selected protocol is enabled during access limitation. Incidentally, an enabled protocol may be defined in advance without requesting the administrator to select one protocol.

When an instruction to start access privilege setting is issued by the administrator, the access privilege policy setting section 15 initializes all the access privileges of the access privilege management table 17 to “none” (step S15) and enables the access privilege setting function of the access control section 16 (step S16). An access privilege setting screen is displayed on the UI 18. When the administrator inputs access privileges necessary for users in accordance with each folder, the inputted access privileges are set in the access privilege management table 17 by the access privilege setting function of the access control section 16.

The access privilege setting screen is ready for an instruction to start access limitation as well as for accepting setting of access privileges. When the administrator issues an instruction to start access limitation, the access privilege policy setting section 15 enables the access control function of the access control section 16 and enables only one of the protocols included in the network communication section 13. In this exemplary embodiment, HTTP is selected when the instruction to start access privilege setting is issued. While only HTTP is restarted and enabled, SMB is kept stopped (step S17). Then, the processing is terminated (step S18).

In the condition that such access limitation is placed, access from respective users through information processing apparatuses such as PCs 20 and an MFP 30 is limited in accordance with the protocol used for access and the contents set in the access privilege management table 17.

In the aforementioned embodiment, though any access request based on SMB is not accepted at all because SMB of the network communication section 13 is stopped and disabled, each access request based on HTTP is accepted by the network communication section 13 and then limited in accordance with the contents set in the access privilege management table 17.

That is, access based on HTTP is processed in accordance with access privileges which are set in the access privilege management table 17 and which are given to users requesting access and given to each folder to be accessed. When the kind of requested access is within the access privilege range (reading of a stored document, addition and storage of a new document, etc.), processing is performed as requested. When the kind of requested access is out of the access privilege range, processing is stopped and a notice indicating forbiddance of processing is given to the user requesting the access.

Next, description will be given to the case where the access limitation is canceled.

When the administrator inputs the administrator's ID and password similarly to the case where access limitation is started (steps S11 and S12), all the protocols are stopped and disabled (step S13).

When an administrator's instruction to cancel the access limitation is accepted through a menu screen displayed on the UI 18 (step S14), the access privilege policy setting section 15 sets “read/write privilege” in all the access privileges in the access privilege management table 17 (step S21), disables the access privilege setting function and the access control function of the access control section 16 (step S22) and starts and enables all the protocols (HTTP and SMB) of the network communication section 13. Then, the processing is terminated (step S18).

Accordingly, all the users can freely gain access again based on all the protocols.

As described above, when access limitation is not desired, free access based on all the protocols is provided. On the other hand, when access limitation is desired, only one of the protocols is enabled and limitation is placed on access accepted by the enabled protocol in accordance with the setting contents of access privileges.

That is, a free access environment and a limited access environment can be selected in accordance with user's desire.

Although this exemplary embodiment has been described on the case where the access management apparatus 10 is provided with the storage section 11 for storing/holding files, the storage section 11 may be provided in another apparatus than the access management apparatus 10 so that access to the files stored/held in the apparatus can be controlled.

Although inputs of various kinds of information from the administrator are accepted by the UI 18 of the access management apparatus 10, inputs of the various kinds of information may be accepted, for example, by another information processing apparatus such as a PC 20 connected through the network N.

The access privilege policy setting section 15 in this exemplary embodiment is provided with a function of giving a notice of enabled protocol information to each user in accordance with start of access limitation, so that the user can check the notice without making efforts to try access based on any disabled protocol.

In this exemplary embodiment, electronic mail addresses of respective users corresponding to user identification information are held in the user management section 12. The access privilege policy setting section 15 gives a notice of enabled protocol information via electronic mail.

What is claimed is:

1. An access management apparatus for managing access to stored files from information processing apparatuses, the access management apparatus comprising:
a network communication section that has a plurality of protocols for accepting access to the files from the information processing apparatuses;
an access privilege policy setting section that enables one of the protocols when limitation of access to the files is started; and
an access control section that limits access to be accepted when the one of the protocols is enabled, in accordance with settings stored in the access control section.

2. The access management apparatus according to claim 1, wherein the access privilege policy setting section disables all the protocols so as to cut off access to the files, before the settings are input to the access control section.

3. A computer readable medium storing a program causing a computer to execute a process for managing access from the information processing apparatuses with use of a plurality of protocols for accepting the access to stored files from the information processing apparatuses, the process comprising:
enabling one of the protocols when limitation of the access to the files is started; and
limiting access to be accepted when the one of the protocols is enabled, in accordance with stored settings.

4. A computer data signal embodied in a carrier wave for enabling a computer to perform a process for managing access from the information processing apparatuses with use of a plurality of protocols for accepting the access to stored files from the information processing apparatuses, the process comprising:
enabling one of the protocols when limitation of the access to the files is started; and
limiting access to be accepted when the one of the protocols is enabled, in accordance with stored settings.

5. An access management method for managing access from information processing apparatuses to a plurality of protocols for accepting the access to stored files from the information processing apparatuses, the method comprising:
enabling one of the protocols when limitation of the access to the files is started; and
limiting access to be accepted when the one of the protocols is enabled, in accordance with stored settings.
